(19) United States
(12) Patent Application Publication
(10) Pub. No.: US 2020/0382470 A1
(43) Pub. Date: Dec. 3, 2020

(54) COMPUTER PROGRAM AND METHOD FOR DETECTING, ANALYZING AND CLASSIFYING SAFE, NON-MALICOUS PROCESSES OR FILES ON A COMPUTING DEVICE

(71) Applicant: Daniel Earl Butler, Overland Park, KS (US)

(72) Inventor: Daniel Earl Butler, Overland Park, KS (US)

(21) Appl. No.: 16/941,528

(22) Filed: Jul. 28, 2020

(51) Int. Cl. H04L 29/06

(52) U.S. Cl. CPC H04L 63/0263

(57) ABSTRACT

Detecting, analyzing and classifying safe, non-malicious processes or files on a computing device includes scanning all currently executing and newly created processes and files to detect if each process or file is safe/non-malicious, largely based on file reputation services, file prevalence, machine learning/artificial intelligence models and the digital signature of the file. The user or administrator is continuously notified and aware that only safe/non-malicious executable code is running on the endpoints at any given time. If any analyzed process or file is not determined to be safe/non-malicious, a network firewall rule is automatically created to block network and/or internet connectivity or deny process creation of the potentially not-safe/malicious process or file completely.

### RELATED APPLICATIONS

This patent application claims priority benefit, with regard to all common subject matter, of earlier-filed U.S. Provisional Patent Application No. 62/885,214, filed Aug. 10, 2019, and entitled “COMPUTER PROGRAM AND METHOD FOR DETECTING, ANALYZING AND CLASSIFYING SAFE, NON-MALICOUS PROCESSES OR FILES ON A COMPUTING DEVICE”. The identified earlier-filed provisional patent applications are hereby incorporated by reference in their entirety into the present application.

### BACKGROUND

### 1. Field

Embodiments of the present invention provide a computer program, a method, and a system for detecting, analyzing and classifying safe, non-malicious processes or files on a computing device. More particularly, embodiments of the present invention scan all currently executing and newly created processes and files to detect if each process or file is safe/non-malicious, largely based on file reputation services, file prevalence, machine learning/artificial intelligence models and the digital signature of the file, to ensure that only safe/non-malicious code is executing at any given time. The application user interface and tray icon are continuously updated to either an “All Safe” or “Not Safe” status and corresponding color and the user or administrator are able to immediately and continuously ascertain that only safe/non-malicious processes or files are currently executing on their endpoints and networks at any given time. If any analyzed process or file is not determined to be safe/non-malicious, network firewall rule is automatically created to block network and/or internet connectivity or deny process creation of the potentially not-safe/malicious process or file completely.

### 2. Related Art

Infection of a computing device by malware is a significant problem for many computer users. Malware authors are skilled at cloaking malware as a legitimate application, such that many computer users unknowingly allow execution of the malware on the user's computing device. To combat this problem, there are many types of malware detection computer programs. A distinction needs to be made between the terms “unsafe” and “not-safe”. Reference herein to “unsafe” implies the process or file is truly malicious, while the term “not-safe” implies the process or file has not been determined to be truly safe/non-malicious, which indicates the maliciousness of the file is currently unknown. Specifically, a not-safe scan result does not necessarily indicate a process or file is unsafe/malicious, rather, a not-safe scan result indicates the process or file is not known to be safe/non-malicious. Ultimately, a “not-safe” file could later be determined to be either safe/non-malicious or unsafe/malicious.

A first type of program, known in the art as blacklisting, attempts to analyze or scan processes or files for indicators of maliciousness to detect if the process or file is unsafe/malicious. This method of malware prevention has many detractions, however. For example, this method is only capable of verifying that a process or file is malicious, and is not capable of verifying that a process or file is safe/non-malicious. As a result, users and administrators are never certain that only known safe/non-malicious processes or files are executing on the computing device at any given time. Moreover, with this first type of malware detection, users and administrators are only somewhat certain that all currently executing and newly created processes and files are not unsafe/malicious, as opposed to being almost certain that only safe/non-malicious processes and files are executing on the computing device at any given time. Additionally, this first type often displays a message similar to “Your computer is protected”, “You are fully protected”, “Your device is safe” or “No threats detected” after a scan is performed, which does not indicate that only safe/non-malicious process or files are executing, rather this only indicates that malware was not detected during the scan. This is in contrast to the present invention which indicates that only safe processes and files are executing at any given time, and after a scan is performed.

A second type of program, known in the art as whitelisting, attempts to analyze or scan processes or files for indicators of non-maliciousness to detect if the process or file is safe/non-malicious, largely based on file reputation services, file prevalence, machine learning/artificial intelligence models and the digital signature of the file. This method of malware prevention is not without its detractions, however. For example, this method typically exhibits an increased false positive rate when scanning all system-wide files on mass storage devices, resulting in increased alert fatigue for the user and administrator.

Accordingly, there is a need for a computer program, a method, and a system that is able to detect safe/non-malicious processes or files and to continuously notify users and administrators that only safe/non-malicious processes or files are executing on the computing device at any given time. If any analyzed process or file is not determined to be safe/non-malicious, a network firewall rule is automatically created to block network and/or internet connectivity or deny process creation of the potentially not-safe/malicious process or file completely.

### SUMMARY

Embodiments of the present invention solve the above-mentioned problems and provide a computer program, a method, and a system for the detection of all currently executing and newly created processes and files safe/non-malicious processes or files on a computing device. Moreover, due to the potential high false positive rate of whitelist and file reputation scan engines, it is typically impractical to scan entire mass storage devices for safe/non-malicious files, and accordingly is the reason the present invention focuses on detection of all currently executing and newly created processes and files safe/non-malicious processes or files on a computing device.

The computer program and method of embodiments of the present invention for the detection of all currently executing and newly created processes and files safe/non-malicious processes or files continuously notifies the user or administrator and makes them aware that only safe/non-malicious executable code is running on the endpoints at any given time. This is in contrast to blacklist scan engines that are only able to notify the user or administrator if unsafe/malicious executable code is running at any given time.

The computer program and method of embodiments of the present invention also includes an automatic network firewall rule generation feature, such that if any analyzed process or file is not determined to be safe/non-malicious, a network firewall rule is automatically created to block network and/or internet connectivity or deny process creation of the potentially not-safe/malicious process or file completely.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

BRIEF DESCRIPTION OF THE DRAWING FIGURES

Embodiments of the present invention are described in detail below with reference to the attached drawing figures, wherein:

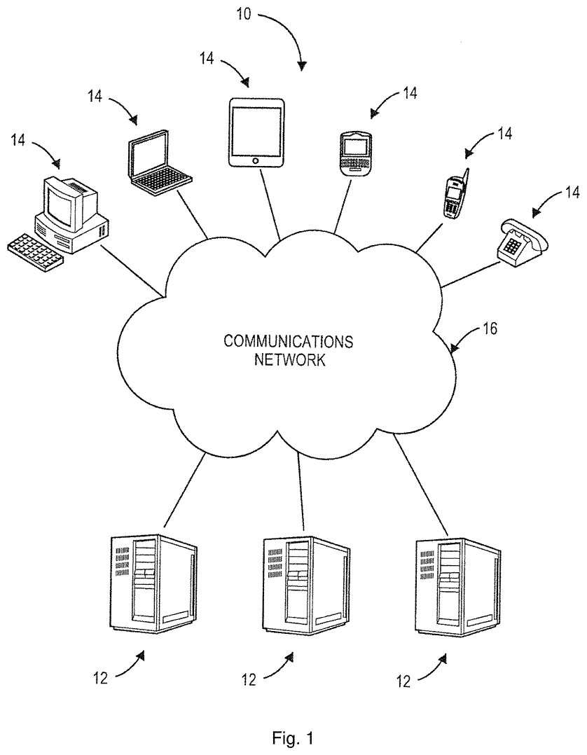

FIG. 1 is a schematic depiction of a system for detecting, analyzing and classifying safe, non-malicious processes or files on a computing device constructed in accordance with various embodiments of the present invention;

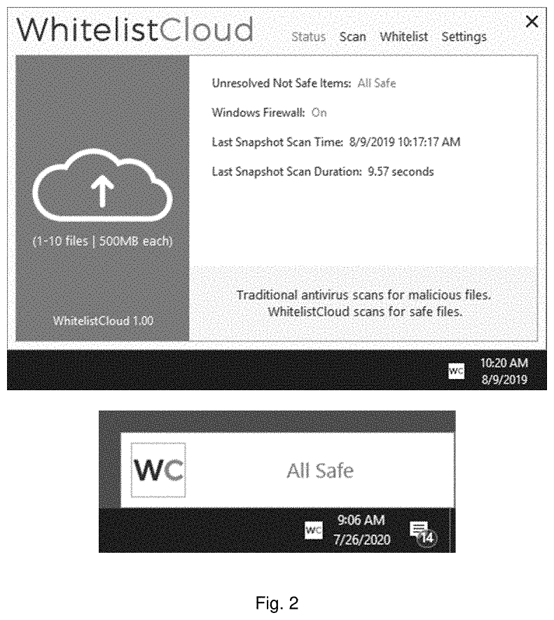

FIG. 2 is a first screen capture of the computer program of embodiments of the present invention and illustrating that only safe/non-malicious processes and files have been encountered on the computing device, and the user or administrator is continuously notified as the “Unresolved Not Safe Items” field is updated to indicate “All Safe”, along with the application tray icon being continuously updated to a predominately white graphic, and a notification indicating “All Safe”;

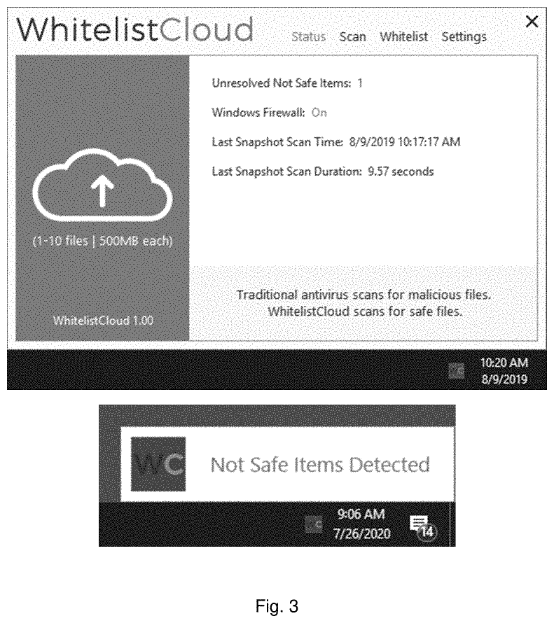

FIG. 3 is a second screen capture of the computer program of embodiments of the present invention and illustrating that one or more potentially not-safe/malicious processes or files have been encountered on the computing device, and the user or administrator is continuously notified as the “Unresolved Not Safe Items” field is updated to indicate the number of potentially not-safe/malicious processes or files, along with the application tray icon being continuously updated to a predominately red graphic, and a notification indicating “Not Safe Items Detected”;

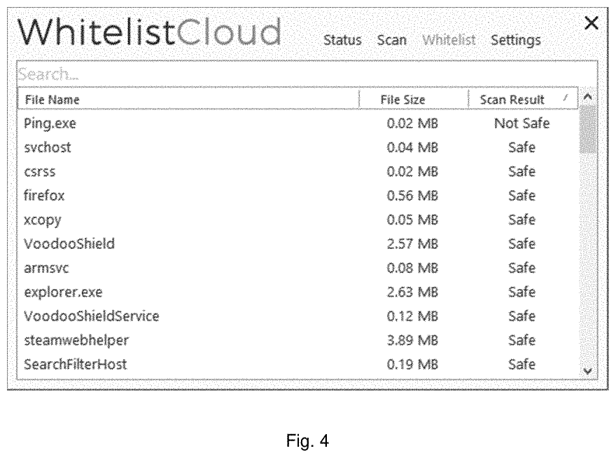

FIG. 4 is a third screen capture of the computer program of embodiments of the present invention and illustrating a process list, consisting of all currently executing and newly created processes and files on the computing device, along with a safe or not-safe scan result for each detected item;

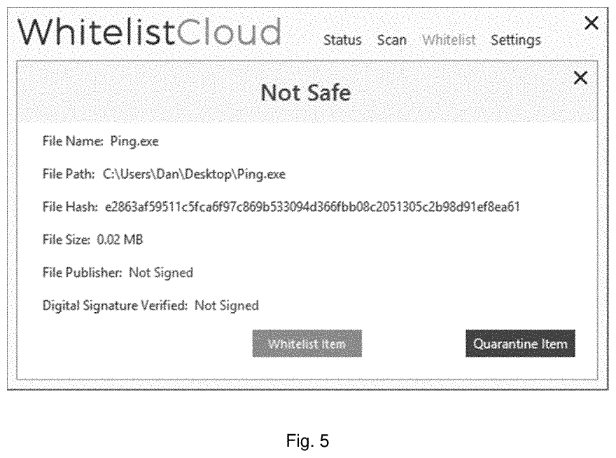

FIG. 5 is a fourth screen capture of the computer program of embodiments of the present invention and illustrating detailed file insight and characteristics of each detected process or file in the FIG. 3 process list, which is displayed when the user or administrator selects one of the items in the FIG. 3 process list. The screen capture also illustrates the manual Whitelist Item and Quarantine Item buttons;

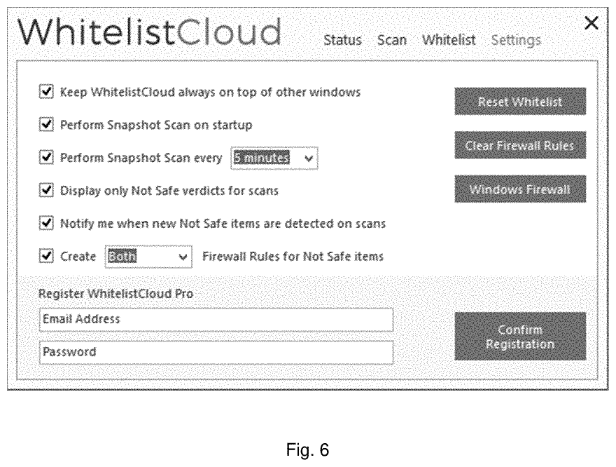

FIG. 6 is a fifth screen capture of the computer program of embodiments of the present invention and illustrating a menu of user-selectable operations for instructing the computer program;

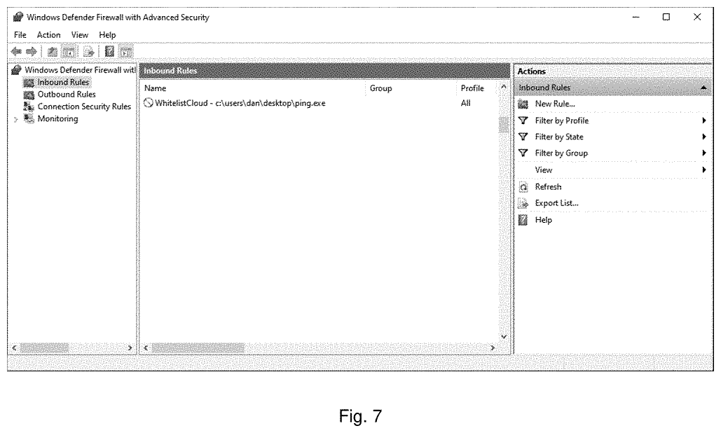

FIG. 7 is a sixth screen capture of the computer program of embodiments of the present invention and illustrating an inbound network firewall rule that is automatically created when a currently executing or newly created process is detected as potentially not-safe/malicious;

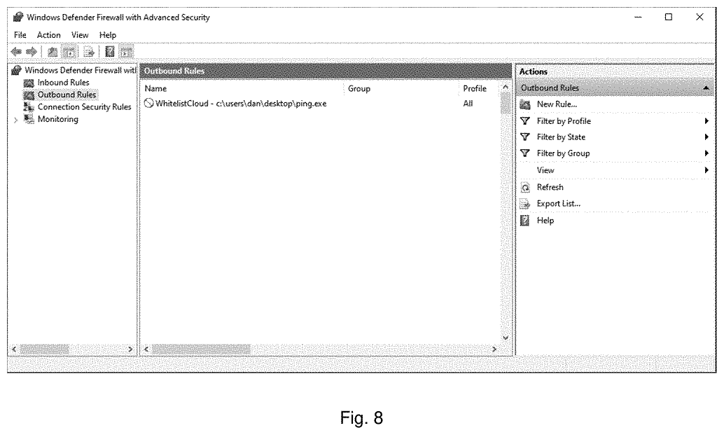

FIG. 8 is a seventh screen capture of the computer program of embodiments of the present invention and illustrating an inbound network firewall rule that is automatically created when a currently executing or newly created process is detected as potentially not-safe/malicious;

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

The present invention provides various embodiments of a computer program, a method, and an antimalware system 10 for detecting, analyzing and classifying safe/non-malicious processes or files on a computing device. The computer program of the present invention performs the function or steps of the method described herein. The computer program is generally referred to herein as the “software.”

When activated and enabled on a computer, the software instantly captures and records an inventory recordation, otherwise referred to herein as a “snapshot” (FIG. 4), of any and all computer processes or files that are currently executing on the computing device. Reference herein to a “process” should be considered to include processes and files.

To provide some background, file reputation services are primarily used within antimalware and cybersecurity software products. Typically, file reputation services are implemented on executable files, script files and other file formats that are subject to carrying unsafe/malicious code. It works by collecting and tracking several attributes of a file, such as prevalence, age, source, signature and overall usage statistics across thousands to millions of users consuming that file. The data is than analyzed within a reputation engine using algorithms and statistical analysis.

More particularly, embodiments of the present invention utilize the exact opposite detection, analysis and scan approach of existing traditional antimalware and cybersecurity products. Traditional antimalware and cybersecurity products analyze or scan processes for indicators of maliciousness to detect if the process is malicious. Instead of analyzing or scanning processes for malicious attributes, embodiments of the present invention analyze or scan all snapshot and newly created processes (pre-execution), to detect if each process is safe/non-malicious, largely based on file reputation services, file prevalence, machine learning/artificial intelligence models and the digital signature of the file. If any analyzed process is not determined to be safe/non-malicious, the user or administrator is notified and a network firewall rule is automatically created (FIGS. 7 & 8) to block network and/or internet connectivity, or deny process creation of the not-safe/malicious process completely.

While there are existing traditional antimalware and cybersecurity products that analyze and scan processes based on file reputation services, there are no existing products that analyze or scan all snapshot and newly created processes (pre-execution) specifically to determine if each process is safe/non-malicious, and to continuously notify the user or administrator that only safe/non-malicious processes are executing at any given time, and to automatically create a network firewall rule to block network and internet connectivity if an item is determined to be not-safe/malicious, which eliminates the chance that the infection will propagate to other endpoints on the network. Moreover, existing products that analyze and scan processes based on file reputation services do not exhibit “passive whitelisting” features such as continuous user and administrator notifications and automatic network firewall rule creation for processes that are not determined to be safe/non-malicious. Furthermore, embodiments of the present invention focus on snapshot and newly created processes (pre-execution), as opposed to system-wide files, which drastically reduces the number of false positives and associated alert fatigue, and provides unprecedented visibility to protect SMB and enterprise endpoints and networks. In short, traditional antimalware and cybersecurity products attempt to detect malicious processes that exist on the endpoint, but they do not indicate that all snapshot and newly created processes (pre-execution) are safe/non-malicious. In other words, traditional antimalware and cybersecurity products focus on and detect malicious processes whereas embodiments of the present invention focus on and detect safe/non-malicious processes.

Embodiments of the present invention continuously monitor all pre-execution and snapshot processes, and if any of the continuously monitored snapshot or newly created processes (pre-execution) are not determined to be safe/non-malicious, the application user interface and tray icon are updated to a “Not Safe” status and predominately red color (FIG. 3). The user or administrator is then able to manually inspect the process for potential maliciousness and subsequently quarantine the process if it is malicious, or manually whitelist the process if it is safe/non-malicious (FIG. 5). If the item is manually whitelisted by the user or administrator, the scan result is automatically changed to “Safe” and the item is added to the whitelist, which will suppress further notifications for this item.

Once all continuously monitored snapshot or newly created processes (pre-execution) are determined to be safe/non-malicious, either by automatic scanning or by the user or administrator manually whitelisting the process (FIG. 5), the application user interface and tray icon are then updated to an “All Safe” status and predominately white color (FIG. 2) and the user or administrator are able to immediately and continuously ascertain that only safe/non-malicious processes are currently executing on their endpoint at any given time. In other words, at any given time, the user and administrators are continuously aware that only safe/non-malicious processes are running on their endpoints and network, which yields unprecedented visibility and drastically reduces alert fatigue.

To ensure only safe/non-malicious processes are allowed to execute unrestricted on an endpoint or network, embodiments of the present invention potentially include a bias in the file reputation analysis, file prevalence analysis and machine learning/artificial intelligence toward not-safe/malicious processes, with little or no regard for false positives.

After a process is analyzed or scanned and is determined to be not-safe/malicious, embodiments of the present invention automatically create an inbound (FIG. 7) and/or outbound (FIG. 8) network firewall rule that blocks network and internet connectivity until the user or administrator has determined that the process is safe/non-malicious and has changed the verdict of the process from “Not Safe” to “Safe”, at which time the network firewall rules are automatically removed. Moreover, after a process is analyzed or scanned and is determined to be not-safe/malicious, embodiments of the present invention deny process creation until the user or administrator has determined that the process is safe/non-malicious and has changed the verdict of the process from “Not Safe” to “Safe” (or whitelisted the process), at which time process creation is allowed.

Furthermore, embodiments of the present invention include application software or a lightweight sensor (FIG. 1) that is installed on endpoints 14 of SMB or enterprise networks that report back to the centralized management console/server 12, where administrators are able to continuously monitor and choose which processes to allow or block (whitelist or blacklist) and are immediately notified if any not-safe/malicious processes are currently executing on their endpoints or network.

### Hardware Description

The computer program and the method of embodiments of the present invention may be implemented in hardware, software, firmware, or combinations thereof using the malware prevention system 10, shown in FIG. 1, which broadly comprises server devices 12, computing devices 14, and a communications network 16. The server devices 12 may include computing devices that provide access to one or more general computing resources, such as Internet services, electronic mail services, data transfer services, and the like. The server devices 12 may also provide access to databases storing each user's or computing device's inventory recordation.

The computing device may include any device, component, or equipment with a processing element and associated memory elements. The processing element may implement operating systems, and may be capable of executing the computer program, which is also generally known as instructions, commands, software code, executables, applications, apps, and the like. The processing element may include processors, microprocessors, microcontrollers, field programmable gate arrays, and the like, or combinations thereof. The memory elements may be capable of storing or retaining the computer program and may also store data, typically binary data, including text, databases, graphics, audio, video, combinations thereof, and the like. The memory elements may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, the server devices 12 may further include file stores comprising a plurality of hard disk drives, network attached storage, or a separate storage network.

The computing devices 14 may include work stations, desktop computers, laptop computers, palmtop computers, tablet computers, portable digital assistants (PDA), smart phones, and the like, or combinations thereof. Various embodiments of the computing device 14 may also include voice communication devices, such as cell phones or landline phones.

The communications network 16 may be wired or wireless and may include servers, routers, switches, wireless receivers and transmitters, and the like, as well as electrically conductive cables or optical cables. The communications network 16 may also include local, metro, or wide area networks, as well as the Internet, or other cloud networks. Furthermore, the communications network 16 may include cellular or mobile phone networks, as well as landline phone networks or public switched telephone networks.

Both the server devices 12 and the computing devices 14 may be connected to the communications network 16. Server devices 12 may be able to communicate with other server devices 12 or computing devices 14 through the communications network 16. Likewise, computing devices 14 may be able to communicate with other computing devices 14 or server devices 12 through the communications network 16. The connection to the communications network 16 may be wired or wireless. Thus, the server devices 12 and the computing devices 14 may include the appropriate components to establish a wired or a wireless connection.

The computer program of the present invention may run on the computing device or, alternatively, may run on one or more server devices 12. Thus, a first portion of the program, code, or instructions may execute on a first server device 12 or the computing device 14, while a second portion of the program, code, or instructions may execute on a second server device 12 or the computing device 14. In some embodiments, other portions of the program, code, or instructions may execute on other server devices 12 as well.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A non-transitory computer-readable storage medium with an executable program stored thereon for detecting, analyzing and classifying safe, non-malicious processes or files on a computing device, wherein the program instructs a processor to perform the steps of:
identify all currently executing and newly created processes and files to detect if each process or file is safe and non-malicious
notifying the user or administrator continuously that only safe and non-malicious executable code is executing in all currently executing and newly created processes
creating a network firewall rule automatically to block network and internet connectivity, or deny process creation, if any analyzed process or file is not determined to be safe and non-malicious
